(19) United States
(12) Patent Application Publication
(10) Pub. No.: US 2026/0170299 A1
(43) Pub. Date: Jun. 18, 2026

(54) CASCADED MACHINE LEARNING (ML) MODEL ARCHITECTURE

(71) Applicant: QUALCOMM Incorporated, San Diego, CA (US)

(72) Inventors: Guilherme HOEFEL, San Diego, CA (US); Diego CALZOLARI, San Diego, CA (US)

(21) Appl. No.: 18/985,576

(22) Filed: Dec. 18, 2024

(51) Int. Cl. G06N 3/045

(52) U.S. Cl. CPC G06N 3/045

(57) ABSTRACT

Certain aspects of the present disclosure provide techniques for wireless communications. An example method includes obtaining sensor data from a sensor; inputting the sensor data to a gating model; obtaining as output from the gating model a first output indicating a change between the sensor data and previous sensor data; inputting the sensor data to a selector model based on the first output; obtaining as output from the selector model a second output indicating an actuator model of a plurality of actuator models, wherein each of the plurality of actuator models is associated with a different classification of sensor data; and causing activation of the actuator model based on the second output.

### FIELD OF THE DISCLOSURE

Aspects of the present disclosure relate to machine learning (ML), and more particularly, to ML model architectures.

### DESCRIPTION OF RELATED ART

Machine learning (ML) models may be used in a variety of different use cases. Generally, an ML model may be used to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

For example, deep learning models may be used to solve complex problems in various domains. Such deep learning models can represent complex non-linear boundaries through multiple layers and nodes. Specific interconnection between layers and nodes allow deep learning models to deliver high performance in various domains. Other types of models may include, for example, convolutional models, recurrent models, transformer models, or the like. Such ML models may be useful in many different use cases, such as image recognition, speech recognition, text-to-speech, natural language processing, computer vision, or the like.

While such ML models may be useful in many use cases, some architectures for ML models may utilize significant resources (e.g., compute cycles, memory resources, etc.) in order to run. Some systems, such as devices, where it may be useful to implement an ML model, however, may have limited resources.

### SUMMARY

Some aspects provide a method for wireless communication by a wireless device. The method includes obtaining sensor data from a sensor; inputting the sensor data to a gating model; obtaining as output from the gating model a first output indicating a change between the sensor data and previous sensor data; inputting the sensor data to a selector model based on the first output; obtaining as output from the selector model a second output indicating an actuator model of a plurality of actuator models, wherein each of the plurality of actuator models is associated with a different classification of sensor data; and causing activation of the actuator model based on the second output.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 depicts an example wireless communications system.

FIG. 2 depicts an example wireless communications device communicating with another device.

FIG. 3 depicts an example conventional machine learning (ML) model.

FIG. 4 depicts an example cascaded ML model architecture.

FIG. 5A illustrates an example gating model, such as of cascaded ML model architecture of FIG. 4.

FIG. 5B illustrates an example selector model, such as of cascaded ML model architecture of FIG. 4.

FIG. 5C illustrates an example actuator model, such as of cascaded ML model architecture of FIG. 4.

FIG. 6 illustrates an example of self-tuning of an ML model of a cascaded ML model architecture, such as the cascaded ML model architecture of FIG. 4.

FIG. 7 depicts an example of a cascaded ML model architecture.

FIG. 8 is an illustrative block diagram of an example artificial neural network (ANN).

FIG. 9 depicts an example method for operating a cascaded ML model architecture.

FIG. 10 depicts aspects of an example device.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatuses, methods, processing systems, and computer-readable mediums for a cascaded machine learning (ML) model architecture.

ML models may be implemented on numerous different types of devices, and may be used for numerous different applications. For example, an ML model may be implemented in a radio frequency (RF) transceiver (also referred to as an RF front-end (RFFE)), such as to determine as output one or more configuration parameters for the RFFE based on input, such as input indicative of an environment in which the RFFE is located.

Some devices where it may be useful to implement an ML model, however, may have limited resources. For example, some devices may have limited memory resources or processing ability, such as systems with a real time operating system (RTOS), Internet of Things (IoT) devices, an RFFE, edge computing devices, extended reality (XR) devices, embedded systems, or the like. Accordingly, there is a technical problem of how to implement ML models on devices with limited resources.

Certain aspects herein provide a cascaded ML model architecture that may provide the technical effect of improved performance of an ML model. Such a cascaded ML model architecture may provide a technical solution to the technical problem by allowing ML models to be implemented on devices with limited resources, while still having suitable performance. For example, a cascaded ML architecture may have a reduced footprint, such as low execution time, low duty cycle requirements, and/or low memory requirements, as compared to a conventional ML model.

In certain aspects, the cascaded ML model architecture includes a cascaded set of multiple ML models, where the output of one ML model may be used as the input to, or to control, another ML model. For example, the problem to be solved by an ML model may be broken into a set of smaller decisions, rather than one large decision to be handled overall by the ML model. Each such decision may be solved by an ML model of the set of ML models. For example, the decision from one ML model may be input to another ML model of the cascaded ML model architecture. In other words, a complex problem can be broken into sub-problems, and each individual sub-problem may be associated with inputs and outputs to an ML model. The outputs of a given ML model that solves a sub-problem may be used downstream to solve other problem(s) by other ML models. The cascaded set of ML models may have the technical benefit of reduced memory usage, reduced computational complexity, and/or improved performance over a traditional single ML model architecture. It should be noted that though certain aspects are discussed herein with respect to use of ML models in a cascaded architecture, some other heuristic may be used instead of an ML model to solve a sub-problem, in some aspects.

In certain aspects, the cascaded ML model architecture may include different types of ML models that form the cascaded set of ML models. For example, a cascaded ML model architecture may include one or more gating models, one or more selector models, and one or more actuator models.

In certain aspects, the cascaded ML model architecture includes a gating model type ML model. A gating model may be any suitable type of ML model, such as a neural network (e.g., a convolutional neural network (CNN), or the like). In certain aspects, a gating model may be a classifier model, such as a Scikit-Learn Multi-layer Perceptron classifier. In certain aspects, a gating model is configured to “gate” as in continue or stop execution of next stages, such as ML models, of the cascaded ML model architecture. In certain aspects, a gating model may be configured to determine whether an input satisfies a change condition. For example, a gating model may be configured to take sensor data as input, and determine whether the sensor data has changed in a manner that satisfies a change condition. For example, the gating model may be configured to determine whether sensor data has changed significantly from previous sensor data. In certain aspects, the gating model “gates” operation of one or more other ML models in the cascaded ML model architecture. For example, if the output of the gating model indicates the input satisfies the change condition, the gating model may cause one or more other ML models, such as a selector model, in the cascaded ML model architecture to process input. If the output of the gating model indicates the input does not satisfy the change condition, the gating model may prevent one or more other ML models in the cascaded ML model architecture from processing input. Accordingly, in certain aspects, the gating model can help save use of computational resources when an input does not satisfy the change condition.

In certain aspects the cascaded ML model architecture includes a selector model type ML model. A selector model may be any suitable type of ML model, such as a neural network (e.g., a CNN, or the like). In certain aspects, a selector model may be a classifier model, such as a Scikit-Learn Multi-layer Perceptron classifier. In certain aspects, a selector model is configured to “select” a stage, such as an ML model, of the cascaded ML model architecture, to be a next stage for execution. A selector model may be configured to activate one or more actuator models (discussed further herein), based on an input. For example, the cascaded ML model architecture may include a plurality of different actuator models, and the selector model may be configured to select at least one (e.g., a subset, one, more than one, etc.) of the plurality of actuator models to process an input. In certain aspects, different actuator models may perform better on different data sets. Accordingly, in certain aspects, a selector model may allow for improved performance through selection of an appropriate actuator model.

In certain aspects, the cascaded ML model architecture includes an actuator model type ML model. An actuator model may be any suitable type of ML model, such as a neural network (e.g., a CNN, or the like). In certain aspects, an actuator model may be a classifier model, such as a Scikit-Learn Multi-layer Perceptron classifier. In certain aspects, an actuator model is configured to infer or make decisions, such as to provide output from the cascaded ML model architecture, or decisions that are relevant to a next stage of the cascaded ML model architecture. In certain aspects, an actuator model may be a type of classifier model. For example, in certain aspects, an actuator model is configured to classify an input to the actuator model, and output a classification for the input, or cause an action to be taken based on the classification for the input. By including multiple actuator models in a cascaded ML model architecture, different actuator models can be trained for different data sets, therefore improving performance of a given actuator model for a defined data set, while allowing flexibility of the cascaded ML model architecture to handle different data sets using different actuator models.

In certain aspects, the cascaded ML model architecture may include any number of gating model(s), selector model(s), and/or actuator model(s). For example, a gating model stage may be followed by any one or more of a gating model stage, a selector model stage, or an actuator model stage. Similarly, a selector model stage may be followed by any one or more of a gating model stage, a selector model stage, or an actuator model stage. Further, an actuator model stage may be followed by any one or more of a gating model stage, a selector model stage, or an actuator model stage. Some stages of the ML model may run in parallel and/or may run in series.

In certain aspects, models of the cascaded ML model architecture may be cascaded horizontally, such that coarse decisions are made upfront at low computational cost, and fine decisions are made later at higher computational cost. For example, ML models with lower resource requirements may be used as earlier stages, and ML models with higher resource requirements may be used as later stages. For example, for image detection of an animal, a coarse model such as a gating model may be used to detect presence of an animal, and a fine model such as an actuator model may be used to detect the type of animal.

In certain aspects, models of the cascaded ML model architecture may be cascaded vertically, such that decisions for orthogonal problems are decoupled. For example, ML models may run in parallel, as certain decisions may not be reliant on one another.

In certain aspects, though the cascaded ML model architecture may include any number of gating model(s), selector model(s), and/or actuator model(s) in any one of various configurations, at least a portion of the cascaded ML model architecture may include a gating model, followed by a selector model, followed by a plurality of actuator models (which may be part of the cascaded ML model architecture or separate from the cascaded ML model architecture, such as operating on a separate device). For example, there may be any number of models (zero or more), along any number of connection paths between models, that lead to a gating model, followed by a selector model, followed by a plurality of actuator models. Including a gating model, followed by a selector model, followed by a plurality of actuator models may provide the technical benefit of the gating model stopping running of an actuator model in some scenarios, which may reduce compute resources used, while the selector model may select an appropriate actuator model for a given input, thereby improving performance.

### Example Wireless Communications System

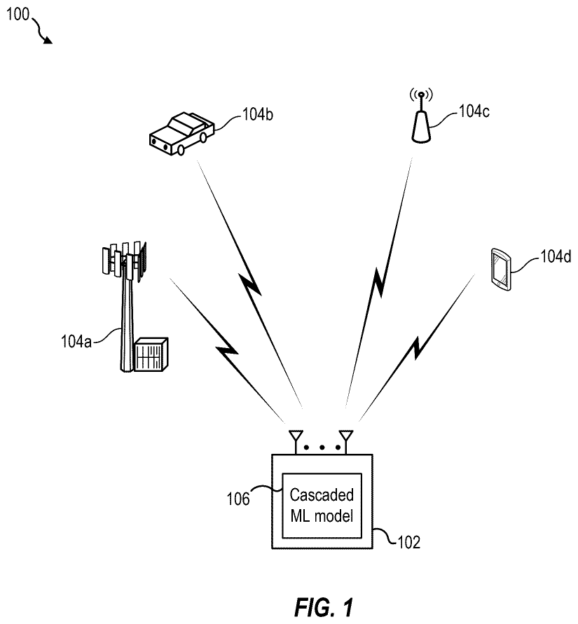

FIG. 1 illustrates an example wireless communications system 100 in which aspects of the present disclosure may be performed. For example, the wireless communications system 100 may include a wireless wide area network (WWAN) and/or a wireless local area network (WLAN). A WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G) or Third Generation (3G) network), a code division multiple access (CDMA) system (e.g., a 2G/3G network), any future WWAN system, or any combination thereof. A WLAN may include a wireless network configured for communications according to an Institute of Electrical and Electronics Engineers (IEEE) standard such as one or more of the 802.11 standards, etc. In some cases, the wireless communications system 100 may include a device-to-device (D2D) communications network or a short-range communications system, such as Bluetooth communications or near field communications (NFC).

As illustrated in FIG. 1, the wireless communications system 100 may include a first wireless device 102 communicating with any of various second wireless devices 104 a-d (hereinafter “the second wireless device 104”) via any of various radio access technologies (RATs), where a wireless device may refer to a wireless communications device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), D2D communications, etc.

The first wireless device 102 may include any of various wireless communications devices including a user equipment (UE), a base station, a wireless station, an access point, customer-premises equipment (CPE), etc. In certain aspects, the first wireless device 102 includes (at least part of) a cascaded ML model architecture 106 that may be used to infer or predict an output, in accordance with aspects of the present disclosure. For example, the cascaded ML model architecture 106 may be configured to provide an output to adjust one or more operational parameters of an RFFE of the first wireless device 102.

For example, first wireless device 102 may be equipped with an RF transceiver (also referred to as an RFFE) for communicating RF signals. In general, a baseband signal is modulated to convey information using a modulation technique, such as phase-shift keying (PSK) or any other suitable modulation technique. In a transmit mode, the RF transceiver is responsible for multiplexing the baseband signal with an RF carrier signal that is transmitted over the air (e.g., a wireless communication channel). Such an operation is called upconversion. In a receive mode, the RF transceiver converts a received RF signal to the baseband signal. Such an operation is called downconversion. The received baseband signal then can be demodulated into the information encoded at a transmitter. The RF transceiver may include a cascade of components in a transmit chain and a receive chain, respectively. The cascade of components may include, for example, one or more of attenuators, switches, couplers, filters, mixers, amplifiers, frequency synthesizers, oscillators, antenna tuners, duplexers, diplexers, detectors, etc. The one or more operational parameters of the RFFE/RF transceiver may include one or more of: an amplifier gain, an antenna tuning, a baseband frequency, an antenna selection, or the like.

The second wireless device 104 may include, for example, a base station 104a, a vehicle 104b, an access point (AP) 104c, and/or a UE 104d. Further, the wireless communications systems 100 may include terrestrial aspects, such as ground-based network entities (e.g., the base station 104a and/or access point 104c), and/or non-terrestrial aspects, such as a spaceborne platform and/or an aerial platform, which may include network entities on-board (e.g., one or more base stations) capable of communicating with other network elements (e.g., terrestrial base stations) and/or user equipment.

The base station 104a may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104d may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

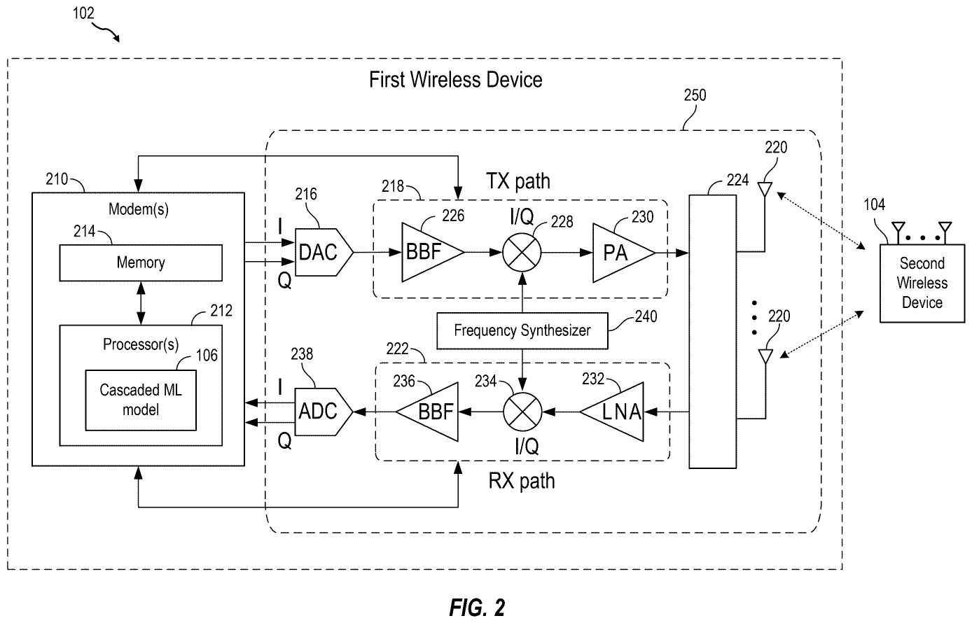

FIG. 2 illustrates example components of the first wireless device 102, which may be used to communicate with any of the second wireless devices 104.

The first wireless device 102 may be, or may include, a chip, system on chip (SoC), system in package (SiP), chipset, package, device that includes one or more modems 210 (hereinafter “the modem 210”). In some cases, the modem 210 may include, for example, any of a WWAN modem (e.g., a modem configured to communicate via E-UTRA, 5G NR, and/or any future WWAN communications standards), a WLAN modem (e.g., a modem configured to communicate via IEEE 802.11 standards), a Bluetooth modem, a NTN modem, etc. In certain aspects, the first wireless device 102 also includes one or more RF transceivers (hereinafter “the RF transceiver 250”). In some cases, the RF transceiver 250 may be referred to as an RFFE. In some aspects, the modem 210 further includes one or more processors, processing blocks or processing elements (hereinafter “the processor 212”) and one or more memory blocks or elements (hereinafter “the memory 214”). In some cases, the processor 212 may implement and/or include the cascaded ML model architecture 106. In certain aspects, the processor 212 and/or the memory 214 are implemented external or otherwise separate from the modem 210.

In certain aspects, the processor 212 may process any of certain protocol stack layers associated with a radio access technology (RAT). For example, the processor 212 may process any of an application layer, packet layer, WLAN protocol stack layers (e.g., a link or a medium access control (MAC) layer), and/or WWAN protocol stack layers (e.g., a radio resource control (RRC) layer, a packet data convergence protocol (PDCP) layer, a radio link control (RLC) layer, and a MAC layer).

The modem 210 may generally be configured to implement a physical (PHY) layer. For example, the modem 210 may be configured to modulate packets and to output the modulated packets to the RF transceiver 250 for transmission over a wireless medium. The modem 210 is similarly configured to obtain modulated packets received by the RF transceiver 250 and to demodulate the packets to provide demodulated packets. In addition to a modulator and a demodulator, the modem 210 may further include digital signal processing (DSP) circuitry, automatic gain control (AGC), a coder, a decoder, a multiplexer, and/or a demultiplexer (not shown).

As an example, while in a transmission mode, the modem 210 may obtain data from a data source, such as an application processor. The data may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 216. In certain aspects involving beamforming, the modulated symbols in the respective spatial streams may be precoded via a steering matrix prior to provision to the IFFT block.

The modem 210 may be coupled to the RF transceiver 250 by a transmit (TX) path 218 (also known as a transmit chain) for transmitting signals via one or more antennas 220 (hereinafter “the antennas 220”) and a receive (RX) path 222 (also known as a receive chain) for receiving signals via the antennas 220. When the TX path 218 and the RX path 222 share the antennas 220, the paths may be coupled to the antennas 220 via an interface 224, which may include any of various suitable RF devices, such as a balun, a transformer, an antenna tuner, a switch, a duplexer, a diplexer, a multiplexer, and or like. As an example, the modem 210 may output digital in-phase (I) and/or quadrature (Q) baseband signals representative of the respective symbols to the DAC 216.

Receiving I or Q baseband analog signals from the DAC 216, the TX path 218 may include a baseband filter (BBF) 226, a mixer 228 (which may include one or several mixers), and a power amplifier (PA) 230. The BBF 226 filters the baseband signals received from the DAC 216, and the mixer 227 mixes the filtered baseband signals with a transmit local oscillator (LO) signal to convert the baseband signal to a different frequency (e.g., upconvert from a baseband frequency to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 228 are typically RF signals, which may be amplified by the PA 230 before transmission by the antennas 220. The antennas 220 may emit RF signals, which may be received at the second wireless device 104. While one mixer 228 is illustrated, several mixers may be used to upconvert the filtered baseband signals to one or more intermediate frequencies and to thereafter upconvert the intermediate frequency signals to a frequency for transmission.

The RX path 222 may include a low noise amplifier (LNA) 232, a mixer 234 (which may include one or several mixers), and a baseband filter (BBF) 236. RF signals received via the antennas 220 (e.g., from the second wireless device 104) may be amplified by the LNA 232, and the mixer 234 mixes the amplified RF signals with a receive local oscillator (LO) signal to convert the RF signal to a baseband frequency (e.g., downconvert the RF signal to the baseband frequency). The baseband signals output by the mixer 234 may be filtered by the BBF 236 before being converted by an analog-to-digital converter (ADC) 238 to digital I or Q signals for digital signal processing. The modem 210 may receive the digital I or Q signals and further process the digital signals, for example, demodulating the digital signals into information.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 240, which may be buffered or amplified by an amplifier (not shown) before being mixed with the baseband signals in the mixer 228. Similarly, the receive LO frequency may be produced by the frequency synthesizer 240, which may be buffered or amplified by an amplifier (not shown) before being mixed with the RF signals in the mixer 234. Separate frequency synthesizers may be used for the TX path 218 and the RX path 222.

While in a reception mode, the modem 210 may obtain digitally converted signals via the ADC 238 and RX path 222. As an example, in the modem 210, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 212) for processing, evaluation, or interpretation.

The modem 210 and/or processor 212 may control the transmission of signals via the TX path 218 and/or reception of signals via the RX path 222. In some aspects, the modem 210 and/or processor 212 may be configured to perform various operations, such as those associated with any of the methods described herein. The modem 210 and/or processor 212 may include a microcontroller, a microprocessor, an application processor, a baseband processor, a MAC processor, an artificial intelligence (AI) processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 214 may store data and program codes (e.g., processor-readable instructions) for performing wireless communications as described herein. In some cases, the memory 214 may be external to the modem 210 and/or processor 212 and/or incorporated therein (as illustrated with the memory 214 or being incorporated with the processor 212).

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

It should be noted that first wireless device 102 is just one example of a computing system that may be used to implement (e.g., run) a cascaded ML model architecture. However, a cascaded ML model architecture, according to any aspects discussed herein, may be implemented on any one or more computing devices. In certain aspects, the cascaded ML model architecture may be split across multiple computing devices. For example, some ML model(s) of the cascaded ML model architecture may run on a first computing device, while some other ML model(s) of the cascaded ML model architecture may run on a second computing device or additional computing device(s). In some aspects, a gating model, followed by a selector model, followed by a plurality of actuator models of the cascaded ML model architecture may run on a given device. In some aspects, a gating model, followed by a selector model, may run on one device, while a following actuator model of the cascaded ML model architecture may run on another device. In some aspects, certain actuator model(s) of the cascaded ML model architecture may run on one device, such as a device with less resources, while certain actuator model(s) of the cascaded ML model architecture may run on another device, such as a device with more resources. For example, if a less complex actuator model is needed for an input, it may run on one device (e.g., locally, at an edge device, etc.), while if a more complex actuator model is needed for the input, it may run on another device (e.g., remotely, at a cloud device, at a device with access to more data such as via a database, etc.).

For example, an actuator model configured to perform simple classification, such as identifying handwritten digits or letters, may be run locally on a device. As an example, a gating model at the device may determine whether a character is present, a selector model at the device may determine whether the character is a number, letter, or special character, and an actuator model at the device, such as trained to identify letters, may determine what letter the character represents.

In another example, an actuator model configured to perform complex classification, such as classifying images of animals into different species, may be run on another device. As an example, a gating model at the device may determine whether an image of an animal is present, a selector model at the device may determine a genus of the animal, and an actuator model at another device (e.g., cloud), such as trained to identify species of a genus, may determine the species of the animal. In such example, the ML model architecture may be configured such that the actuator model(s) always run on another device. In other configurations, the output of the selector model may be used to identify either an actuator model that runs on the device or an actuator model that runs on another device.

### Example Cascaded ML Model Architecture

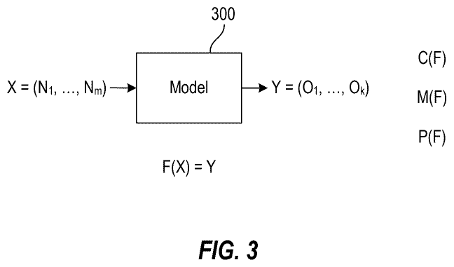

FIG. 3 depicts an example conventional ML model 300. As shown, ML model 300 is configured to take as input, data set X, which may include m data samples N. The ML model 300 is configured to produce as output, data set Y, which may include k data samples O. Accordingly, the ML model 300 may be modeled as the function F(X) which produces the output Y. Operation of the ML model 300 may have a duty cycle C(F), a memory footprint M(F), and a performance P(F). In certain aspects, the duty cycle is the percentage of the time the ML model 300 runs compared to the time it does not run over a time period. In certain aspects, the memory footprint is the amount of memory resources used for running the ML model 300. In certain aspects, the performance is a performance metric, such as accuracy of output, speed of output, or the like.

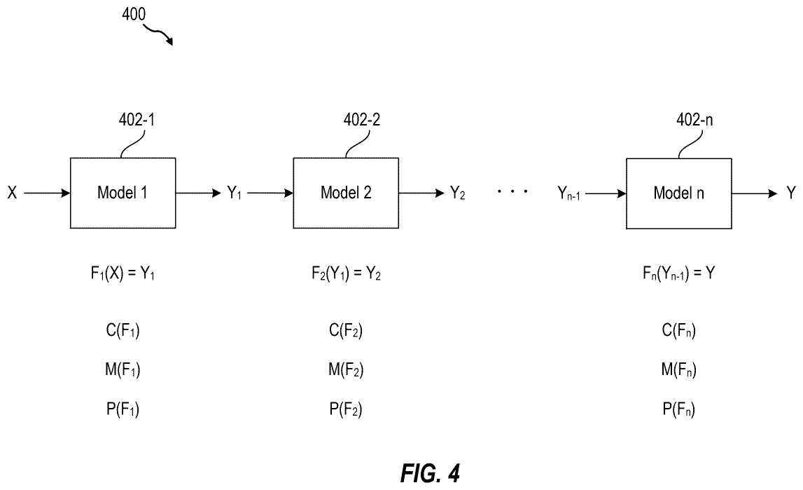

FIG. 4 depicts an example cascaded ML model architecture 400 (e.g., the cascaded ML model architecture 106 of FIGS. 1 and/or 2), according to certain aspects. As shown, cascaded ML model architecture 400 includes a plurality of ML models 402, shown as ML model 402-1 through 402-n. As discussed, in certain aspects, each ML model 402 may represent a sub-problem or decision of the overall problem or decision handled by ML model 300. As shown, in certain aspects, the output of one ML model 402 may be used as an input to another ML model 402. For example, the output Y₁ of ML model 402-1 may serve as an input to ML model 402-2. The overall cascaded ML model architecture 400 may take as input data set X and output data set Y, like ML model 300.

Each ML model 402-i of the cascaded ML model architecture 400 may have an associated duty cycle C(Fᵢ), a memory footprint M(Fᵢ), and a performance P(Fᵢ). Accordingly, the overall duty cycle of cascaded ML model architecture 400 may be C(F₁)+. . . +C(Fₙ), the overall memory footprint may be M(F₁)+. . . +M(Fₙ), and the overall performance may be P(F)=P(F₁)+. . . +P(Fₙ). In certain aspects, the overall duty cycle of cascaded ML model architecture 400 is less than the duty cycle of ML model 300, C(F₁)+. . . +C(Fₙ)<C(F). In certain aspects, the overall memory footprint of cascaded ML model architecture 400 is less than the memory footprint of ML model 300, M(F₁)+. . . +M(Fₙ)<M(F). In certain aspects, the overall performance of cascaded ML model architecture 400 is greater than or equal to the performance of ML model 300, P(F₁)+. . . +P(Fₙ)≥P(F). For example, in certain aspects, the number of layers and nodes needed to implement a neural network corresponding to cascaded ML model architecture 400 may be less than the number of layers and nodes needed to implement a neural network corresponding to ML model 300. For example, in some cases, each ML model of cascaded ML model architecture 400 may have a single hidden layer, and 10 nodes or less.

In certain aspects, the ML model 402-1 may be a gating model, the ML model 402-2 may be a selector model, and the ML model 402-n may be an actuator model. In certain aspects, the data set X may be input into the ML model 402-1, which determines whether to activate the ML model 402-2. The output Y₁ of the ML model 402-1 may include an indication of whether to activate the ML model 402-2. The ML model 402-2 may receive the output Y₁ (e.g., as well as the data set X) as input, and may process the input (e.g., data set X) when the output Y₁ indicates to activate the ML model 402-2. The ML model 402-2, based on the input (e.g., data set X), may determine which actuator model to select. Accordingly, the Y₂ of ML model 402-2 may include an indication of a selection of an actuator model, among a plurality of actuator models. The ML model 402-n may receive the output Y₂ selecting ML model 402-n (e.g., as well as the data set X or a subset thereof) as input, and may process the input (e.g., data set X or a subset) to produce output Y.

As an illustrative example, the input X may be a set of images from an image sensor, and the output Y may be an identification of a breed of cat or dog depicted in each image. In certain aspects, the ML model 402-1, acting as a gating model, may be configured to take an image as input and determine whether the image includes an animal (e.g., sensor input has changed to include an object such as an animal). When the image includes an animal, the ML model 402-1 may activate ML model 402-2, which acting as a selector model, takes the image as input and may select between a first actuator model configured to identify breeds of cats, and a second actuator model configured to identify breeds of dogs. In certain aspects, ML model 402-2 may be trained to identify whether an image includes a dog or cat, and select an actuator model accordingly. If the image includes a dog, the ML model 402-2 may select the second actuator model. The second actuator model may be configured to take the image as input, and indicate a breed of dog in the image as output.

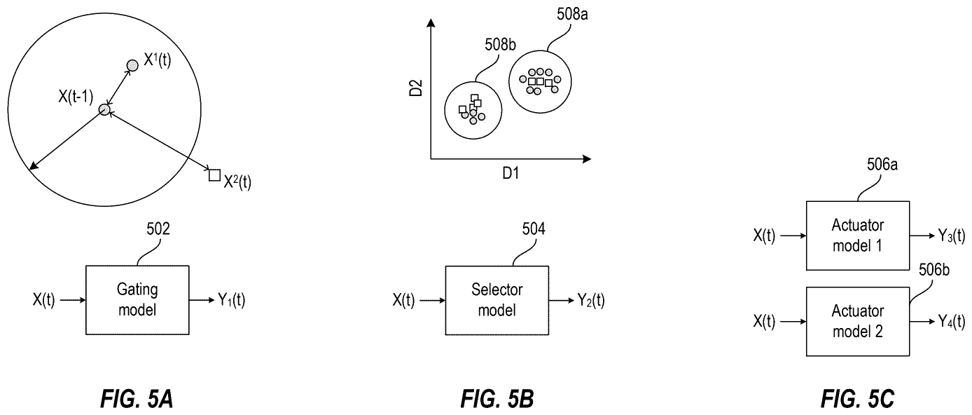

FIG. 5A illustrates an example gating model 502, such as of cascaded ML model architecture 400 of FIG. 4. In certain aspects, gating model 502 is configured to act as a change detector, such as between an input Xₜ at a time t (e.g., corresponding to sensor data such as from an image sensor, current sensor, voltage sensor, or the like) and an input Xₜ₋₁ at a previous time t-1. For example, the gating model 502 may only activate a subsequent ML model when the change between Xₜ and Xₜ₋₁ is large. In certain aspects, gating model 502 is trained to learn a perceptron with two edges for detecting small versus large changes. The gating model 502 may learn the distance between samples from the same class (e.g., small or large change) versus the distance between classes. For example, as shown, X¹ₜ may be a small change from Xₜ₋₁ and be in the same class as Xₜ₋₁. X²ₜ may be a large change from Xₜ₋₁ and be in a different class than Xₜ₋₁.

FIG. 5B illustrates an example selector model 504, such as of cascaded ML model architecture 400 of FIG. 4. In certain aspects, selector model 504 is configured to select which actuator model (e.g., classifier model) to activate. For example, selector model 504 may be trained to identify to which area (e.g., general class) an input belongs. In certain aspects, the selector model 504 is configured to select the actuator model with the number of edges of a single hidden layer that maximizes correct classification of the input, and minimizes the number of nodes of the actuator model. For example, as shown there are two areas 508a and 508b along two dimensions D1 and D2 (e.g., representing two parameters of the input). Each area 508a and 508b, may be associated with an actuator model 506a and 506b of FIG. 5C, such as of cascaded ML model architecture 400 of FIG. 4, respectively. The selector model 504 may take an input Xₜ, determine whether it is associated with area 508a or 508b, and select the associated actuator model 506a or 506b. In certain aspects, each actuator model 506a and 506b may be trained in data associated with the corresponding area 508a or 508b, and not the other area.

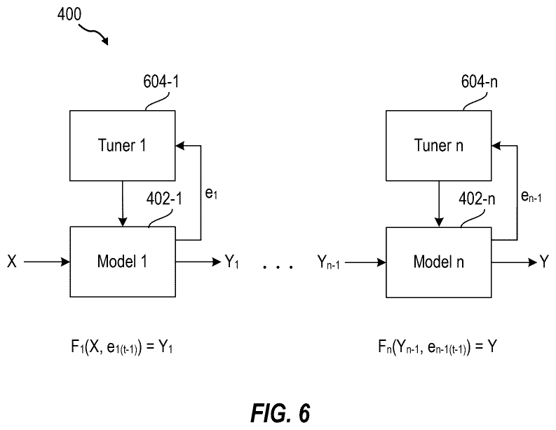

FIG. 6 illustrates an example of self-tuning of an ML model of a cascaded ML model architecture, such as the cascaded ML model architecture 400 of FIG. 4. In certain aspects, an ML model of the cascaded ML model architecture may be trained, such as self-tuned, such as to improve performance of the ML model. For example, as shown each ML model 402-1 through 402-n of the cascaded ML model architecture 400 may be associated with a tuner 604-1 through 604-n, respectively. A tuner 604 may be configured to adjust one or more parameters (e.g., weights) of a corresponding ML model 402 based on an error value (e.g., error signal) e associated with an output of the ML model 402. For example, the weights of the ML model 402 may be updated using gradient descent, or some other suitable supervised or unsupervised learning technique. In certain aspects, tuning of the ML model may occur when one or more conditions are met, such as a device including the ML model is idle, a certain time of day, a threshold amount of new data (e.g., error values) are obtained, or the like.

In certain aspects, where the ML model 402 is a gating model, and a ground truth corresponding to the expected output for an input data X is available, the gating model may be retrained when a minimum distance between data points for different classification labels (e.g., small or large change, as discussed) decreases (e.g., by a threshold). In certain aspects, where the ML model 402 is a gating model, and a ground truth corresponding to the expected output for an input data X is not available, the gating model may be updated when a minimum distance between data points for different classification labels (e.g., small or large change, as discussed) decreases (e.g., by a threshold). For example, if a distance between a value X¹ₜ and X²ₜ as shown in FIG. 5A decreases, the gating model may be retrained or updated.

In certain aspects, where the ML model 402 is a selector model, and a ground truth corresponding to the expected output for an input data X is available, the selector model may be retrained when new samples do not belong to existing classification areas (e.g., hyperspheres). For example, if an input data X includes a sample that is not in either area 508a or 508b, as shown in FIG. 5B, then the selector model may be updated or retrained to include a new area (e.g., corresponding to a new classification) corresponding to the sample. Further, in certain aspects, based on the selector model being updated to include a new area, a new actuator model may be added to the cascaded ML model architecture, where the new actuator model is associated with the new area.

In certain aspects, where the ML model 402 is a selector model, and a ground truth corresponding to the expected output for an input data X is not available, the selector model may select the closest classification area for an input data X when the input data X does not belong to the existing classification areas. Further, the confidence score of the model in the classification of such input data X may be decreased. In addition, the actuator model selected by the selector model may be the one associated with the selected area, and the confidence score for the output of the actuator model may be lowered (e.g., based on a distance of the input data X from the classification area selected).

Accordingly, in certain aspects, the cascaded ML model architecture 400 may be self-tuned, in that it can be updated and/or retrained as new input is run through cascaded ML model architecture 400, allowing cascaded ML model architecture 400 to improve in performance and evolve over time.

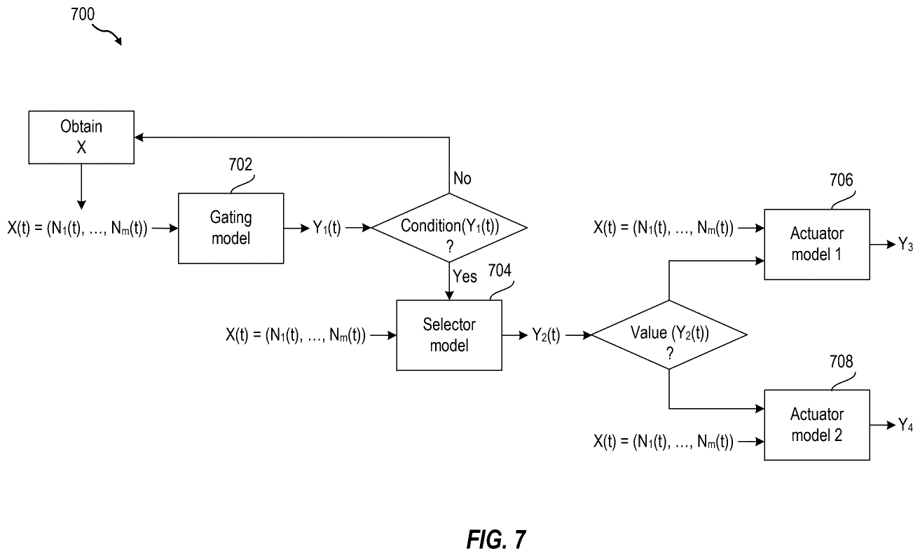

FIG. 7 depicts an example of a cascaded ML model architecture 700 (e.g., the cascaded ML model architecture 106 of FIGS. 1 and/or 2), according to certain aspects. As shown, an input X(t) is input to a gating model 702, which generates an output Y₁(t). If Y₁(t) satisfies a change condition, a selector model 704 is activated. If Y₁(t) does not satisfy the change condition, the selector model 704 is not activated.

If the selector model 704 is activated, the input X(t) is input to selector model 704, which generates an output Y₂(t). The output Y₂(t) may indicate a selection of one of actuator model 706 or actuator model 708. Whichever of actuator model 706 or actuator model 708 is selected is activated and configured to take as input X(t) and generate a corresponding output Y₃(t) or Y₄(t). Two actuator models 706, 708 are illustrated, but any number of actuator models may be implemented.

In some examples, the selector model 704 is further configured to select a subset of data from X and provide the subset of data to a selected actuator model(s) instead of X(t). For example, the subset may include only a relevant portion of the input X(t), such as a portion of an image or a subset of sensor readings. The subset may be the same regardless of which actuator model(s) is selected (e.g., model 706 receives X₁(t) and/or model 708 receives X₁(t)) or different actuator models receive different sets of data (e.g., model 706 receives X₂(t) and/or model 708 receives X₃(t) or X(t), where Xᵢ represents a respective subset of data such as “r” data samples N, where r<m).

### Example Use Cases of a Cascaded ML Model Architecture

A cascaded ML model architecture, according to aspects discussed herein, may be used for any of various use cases. For example, in certain aspects, the cascaded ML model architecture may run in an RFFE or be used to control an RFFE. In certain aspects, the sensor data input to such a cascaded ML model architecture may be data pertaining to a user interaction of a device including the RFFE. For example, a user interaction may include the device being held primarily on the right side, thereby blocking or attenuating some signaling on the right side of the device. In another example, a user interaction may include the device being held primarily on the left side, thereby blocking or attenuating some signaling on the left side of the device. Sensor data corresponding to such user interaction may include one or more of gyroscope sensor data, RF interference data, touch sensor data, or the like. In certain aspects, the cascaded ML model architecture, based on the input sensor data, may be configured to adapt (e.g., tune) one or more parameters of the RFFE, such as an aperture switch or aperture tuner or impedance tuner configuration on one or more antennas of the device, beamforming parameters (e.g., weights and/or phases, or a codebook selection), gain of one or more amplifiers, etc. For example, the cascaded ML model architecture may include a gating model configured to determine if sensor values have changed from previously detected values (e.g., a large change, for example a grip of the user substantially changing) such that adapting one or more parameters of the RFFE is warranted. The cascaded ML model architecture may further include a selector model configured to select an actuator model based on the detected user interaction. For example, a first actuator model may be trained to handle generating RFFE parameters value(s) for a device being held primarily on the right side, and a second actuator model may be trained to handle generating RFFE parameters value(s) for a device being held primarily on the left side.

In certain aspects, the cascaded ML model architecture may be used for computer vision applications, such as object identification. For example, the sensor data input to such a cascaded ML model architecture may be data pertaining to an environment, such as image data, point cloud data, LIDAR data, etc. In certain aspects, the cascaded ML model architecture, based on the input sensor data, may be configured to identify one or more objects in a scene. For example, the cascaded ML model architecture may include a gating model configured to determine if sensor values have changed from previously detected values (e.g., a large change) such that a new object has entered the scene. The cascaded ML model architecture may further include a selector model configured to select an actuator model based on the detected object. For example, a first actuator model may be trained to handle inanimate objects, while a second actuator model may be trained to handle people.

In certain aspects, the cascaded ML model architecture may be used for detection of a gesture, such as a gesture preformed near a mobile device such as a phone or laptop. For example, the sensor data input to such a cascaded ML model architecture may be data pertaining to an environment, such as radar data, image data, point cloud data, LIDAR data, etc. In certain aspects, the cascaded ML model architecture, based on the input sensor data, may be configured to determine a gesture performed by a user in the vicinity of a device. For example, the cascaded ML model architecture may include a gating model configured to determine if sensor values have changed from previously detected values (e.g., a large change) such that a user's hand or limb is moving near the device. The cascaded ML model architecture may further include a selector model configured to select an actuator model based on the detected movement. For example, a first actuator model may be trained to handle slow gestures performed by a single hand or limb, a second actuator model may be trained to handle fast gestures performed by a single hand or limb, and third actuator model may be trained to handle gestures performed by multiple hands or limbs.

In certain aspects, the cascaded ML model architecture may be used for internet of things (IoT) applications, such as the identification of certain events or statuses of a tracking tag or label. For example, the sensor data input to such a cascaded ML model architecture may be data pertaining to an environment in which the tag or label is located and/or movement of the tag or label, such as temperature data, acceleration data, pose data, location (e.g., GNSS) data, etc. In certain aspects, the cascaded ML model architecture, based on the input sensor data, may be configured to identify an event associated with the tag or label or a status of the tag or label. For example, the cascaded ML model architecture may include a gating model configured to determine if sensor values have changed from previously detected values (e.g., a large change) such that the tag or label has changed states. The cascaded ML model architecture may further include a selector model configured to select an actuator model based on the detected object. For example, a first actuator model may be trained to handle expected transit events (e.g., determination that the tag or label is driving on a vehicle, flying on a plane, etc.), while a second actuator model may be trained to handle exceptional or alarming events (e.g., determination of potential overheating, of being dropped from an excessive height or with excessive force, etc). It will be appreciated that the cascaded ML model architecture described herein may be used for other functions or purposes (e.g., vehicle control, industrial monitoring, etc.).

### Example ML Models

As discussed, the various ML models of a cascaded ML model architecture, may be trained or tuned. ML is often characterized in terms of types of learning that generate specific types of learned models that perform specific types of tasks. For example, different types of machine learning include supervised learning, unsupervised learning, semi-supervised learning, and reinforcement learning. In certain aspects, an ML model of a cascaded ML model architecture may be trained or tuned using such learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)), such as to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model in the cascaded ML model architecture, such as an ANN. It should be understood, however, that other type(s) of AI models may be used in addition to or instead of an ANN. An ML model may be an example of an AI model, and any suitable AI model may be used in addition to or instead of any of the ML models described herein in a cascaded ML model architecture. Hence, unless expressly recited, subject matter regarding an ML model is not necessarily intended to be limited to just an ANN solution. Further, it should be understood that, unless otherwise specifically stated, terms such as “AI model,” “ML model,” “AI/ML model,” “trained ML model,” and the like are intended to be interchangeable.

### Example Artificial Intelligence Model

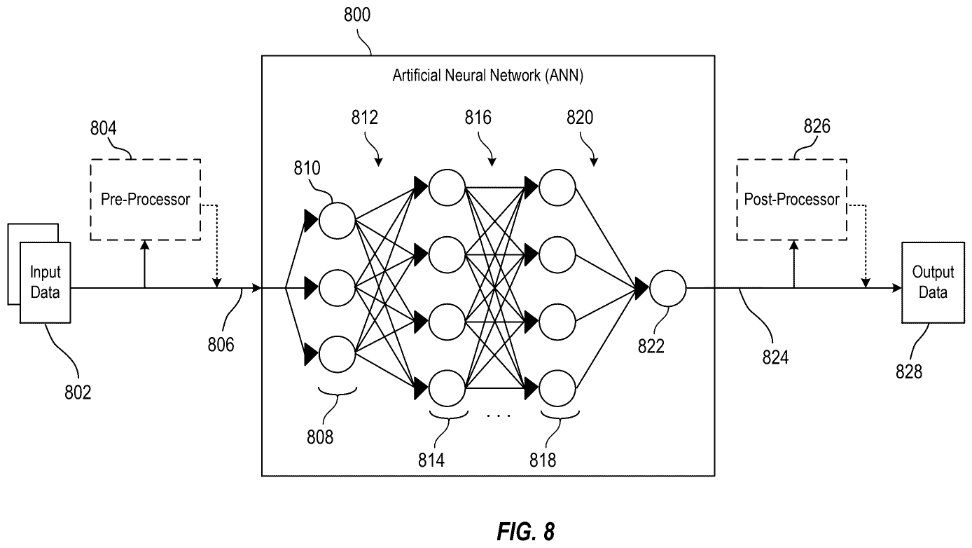

FIG. 8 is an illustrative block diagram of an example artificial neural network (ANN) 800.

ANN 800 may receive input data 806 which may include one or more bits of data 802, pre-processed data output from pre-processor 804 (optional), or some combination thereof. Here, data 802 may include training data, verification data, application-related data, or the like, e.g., depending on the stage of development and/or deployment of ANN 800. Pre-processor 804 may be included within ANN 800 in some other implementations. Pre-processor 804 may, for example, process all or a portion of data 802 which may result in some of data 802 being changed, replaced, deleted, etc. In some implementations, pre-processor 804 may add additional data to data 802.

ANN 800 includes at least one first layer 808 of artificial neurons 810 (e.g., perceptrons) to process input data 806 and provide resulting first layer output data via edges 812 to at least a portion of at least one second layer 814. Second layer 814 processes data received via edges 812 and provides second layer output data via edges 816 to at least a portion of at least one third layer 818. Third layer 818 processes data received via edges 816 and provides third layer output data via edges 820 to at least a portion of a final layer 822 including one or more neurons to provide output data 824. All or part of output data 824 may be further processed in some manner by (optional) post-processor 826. Thus, in certain examples, ANN 800 may provide output data 828 that is based on output data 824, post-processed data output from post-processor 826, or some combination thereof. Post-processor 826 may be included within ANN 800 in some other implementations. Post-processor 826 may, for example, process all or a portion of output data 824 which may result in output data 828 being different, at least in part, to output data 824, e.g., as result of data being changed, replaced, deleted, etc. In some implementations, post-processor 826 may be configured to add additional data to output data 824. In this example, second layer 814 and third layer 818 represent intermediate or hidden layers that may be arranged in a hierarchical or other like structure. Although not explicitly shown, there may be one or more further intermediate layers between the second layer 814 and the third layer 818, or only one such intermediate or hidden layer.

The structure and training of artificial neurons 810 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., X in FIG. 4). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 800 and a number of layers and a number of artificial neurons in each layer, as well as selecting activation functions, a loss function, training processes, etc. Once an initial model has been designed, training of the model may be conducted using training data. Training data may include one or more datasets within which ANN 800 may detect, determine, identify or ascertain patterns. Training data may represent various types of information, including written, visual, audio, environmental context, operational properties, etc. During training, parameters of artificial neurons 810 may be changed, such as to minimize or otherwise reduce a loss function or a cost function. A training process may be repeated multiple times to fine-tune ANN 800 with each iteration.

Various ANN model structures are available for consideration. For example, in a feedforward ANN structure each artificial neuron 810 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

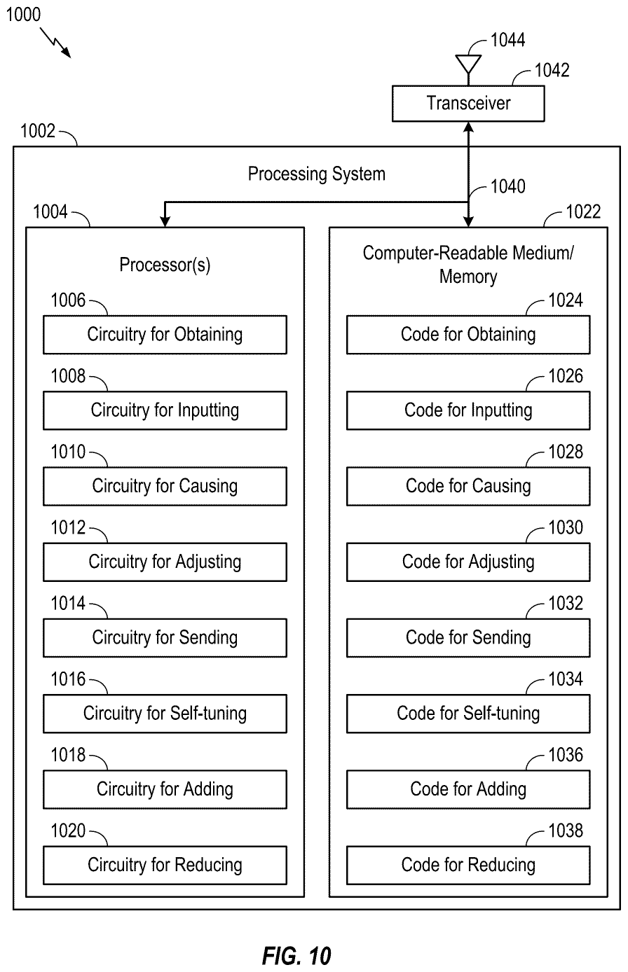

ANN 800 or other ML models may be implemented in various types of processing circuits along with memory and applicable instructions therein, for example, as described herein with respect to FIGS. 2 and 10. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 800 of FIG. 8, or other model 402 of FIG. 4.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 800 of FIG. 8, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Example Operations

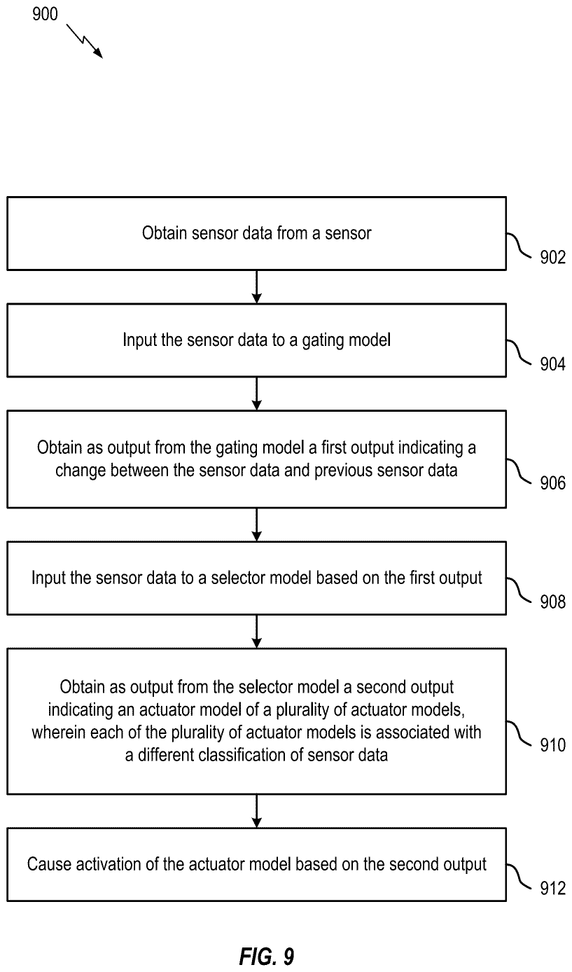

FIG. 9 illustrates example operations 900 by a device, such as a first wireless device 102 or a second wireless device 104 of FIGS. 1 and 2, or any computing device. The operations 900 may be performed, for example, by a device (e.g., the first wireless device 102 in the wireless communications system 100). The operations 900 may be implemented as software components that are executed and run on one or more processors (e.g., the modem 210 and/or the processor 212 of FIG. 2).

The operations 900 may optionally begin, at block 902, where the device may obtain sensor data from a sensor

At block 904, the device may input the sensor data to a gating model.

At block 906, the device may obtain as output from the gating model a first output indicating a change between the sensor data and previous sensor data.

At block 908, the device may input the sensor data to a selector model based on the first output.

At block 910, the device may obtain as output from the selector model a second output indicating an actuator model of a plurality of actuator models, wherein each of the plurality of actuator models is associated with a different classification of sensor data.

At block 912, the device may cause activation of the actuator model based on the second output.

In some aspects, block 912 includes inputting at least a portion of the sensor data to the actuator model and obtaining as output from the actuator model a third output.

In some aspects, operations 900 further includes adjusting operation of a RFFE based on the third output.

In some aspects, adjusting operation of the RFFE based on the third output comprises adjusting an amplifier gain (e.g., of the PA 230), an aperture or impedance tuner or switch configuration of one or more antennas, and/or beamforming parameters.

In some aspects, the third output comprises a classification of an object in an environment; and the sensor data comprises a representation of the environment.

In some aspects, block 912 includes sending a signal to a device comprising the actuator model.

In some aspects, the sensor comprises an antenna, a touch screen, a button, a motion sensor, a touch or capacitive sensor, or a light sensor.

In some aspects, block 908 includes inputting the sensor data to the selector model in response to the first output indicating the change between the sensor data and previous sensor data satisfies a condition.

In some aspects, the gating model comprises a first neural network with a first input layer configured to receive the sensor data and a first output layer configured to output the first output; the selector model comprises a second neural network with a second input layer configured to receive the sensor data and a second output layer configured to output the second output; and the actuator model comprises a third neural network with a third input layer configured to receive the sensor data and a third output layer configured to output a third output.

In some aspects, operations 900 further include self-tuning the gating model in response to a decrease in a minimum distance between data points associated with different classifications associated with the gating model.

In some aspects, operations 900 further include self-tuning the selector model to add a classification associated with the selector model in response to a data point outside current classifications associated with the selector model.

In some aspects, operations 900 further include adding another actuator model to the plurality of actuator models, wherein the other actuator model is associated with the added classification.

In some aspects, operations 900 further include self-tuning the selector model to reduce a confidence score associated with the selector model in response to a data point outside current classifications associated with the selector model.

In some aspects, operations 900 further include reducing a second confidence score associated with the actuator model in response to the data point outside the current classifications associated with the selector model.

In some aspect, operations 900, or any related aspects, may be performed by an apparatus, such as device 1000 of FIG. 10, which includes various components operable, configured, or adapted to perform the operations 900. Device 1000 is described below in further detail.

Note that FIG. 9 is just one example of a method, and other methods including fewer, additional, or alternative operations are possible consistent with this disclosure.

### Example Device

FIG. 10 depicts aspects of an example device 1000. In some aspects, device 1000 is a wireless communication device, such as the first wireless device 102 described above with respect to FIGS. 1 and 2.

The device 1000 includes a processing system 1002, optionally coupled to a transceiver 1042 (e.g., a transmitter and/or a receiver). The optional transceiver 1042 is configured to transmit and receive signals for the device 1000 via an antenna 1044, such as the various signals described herein. The processing system 1002 may be configured to perform processing functions for the device 1000, such as processing signals received and/or to be transmitted by the device 1000.

The processing system 1002 includes one or more processors 1004. In various aspects, the one or more processors 1004 may be representative of any of the modem 210 and/or the processor 212, as described with respect to FIG. 2. The one or more processors 1004 are coupled to a computer-readable medium/memory 1022 via a bus 1040. In certain aspects, the computer-readable medium/memory 1022 is configured to store instructions (e.g., computer-executable code) that when executed by the one or more processors 1004, cause the one or more processors 1004 to perform the operations 900 described with respect to FIG. 9, or any aspect related to the operations described herein. Note that reference to a processor performing a function of device 1000 may include one or more processors performing that function of device 1000. Reference to one or more processors performing multiple functions may include any one of the one or more processors performing any one of the multiple functions.

In the depicted example, computer-readable medium/memory 1022 stores code (e.g., executable instructions), including code for obtaining 1024, code for inputting 1026, code for causing 1028, code for adjusting 1030, code for sending 1032, code for self-tuning 1034, code for adding 1036, code for reducing 1038, or any combination thereof. Processing of the code 1024-1038 may cause the device 1000 to perform the operations 900 described with respect to FIG. 9, or any aspect related to operations described herein.

The one or more processors 1004 include circuitry configured to implement (e.g., execute) the code stored in the computer-readable medium/memory 1022, including circuitry for obtaining 1006, circuitry for inputting 1008, circuitry for causing 1010, circuitry for adjusting 1012, circuitry for sending 1014, circuitry for self-tuning 1016, circuitry for adding 1018, circuitry for reducing 1020, or any combination thereof. Processing with circuitry 1006-1020 may cause the device 1000 to perform the operations 900 described with respect to FIG. 9, or any aspect related to operations described herein.

Various components of the device 1000 may provide means for performing the operations 900 described with respect to FIG. 9, or any aspect related to operations described herein. For example, means for transmitting, sending or outputting for transmission may include the TX path 218 and/or antenna(s) 220 of the first wireless device 102 illustrated in FIG. 2 and/or transceiver 1042 and antenna 1044 of the device 1000 in FIG. 10. Means for receiving or obtaining may include the RX path 222 and/or antenna(s) 220 of the first wireless device illustrated in FIG. 2 and/or transceiver 1042 and antenna 1044 of the device 1000 in FIG. 10. Means for obtaining, inputting, causing, adjusting, self-tuning, adding, and/or reducing may include one or more processors, such as the modem 210 and/or processor 212 depicted in FIG. 2 and/or the processor(s) 1004 in FIG. 10.

### Example Aspects

Implementation examples are described in the following numbered aspects:

Aspect 1: A method comprising: obtaining sensor data from a sensor; inputting the sensor data to a gating model; obtaining as output from the gating model a first output indicating a change between the sensor data and previous sensor data; inputting the sensor data to a selector model based on the first output; obtaining as output from the selector model a second output indicating an actuator model of a plurality of actuator models, wherein each of the plurality of actuator models is associated with a different classification of sensor data; and causing activation of the actuator model based on the second output.

Aspect 2: The method of Aspect 1, wherein causing activation of the actuator model comprises inputting at least a portion of the sensor data to the actuator model; and obtaining as output from the actuator model a third output.

Aspect 3: The method of Aspect 2, further comprising: adjusting operation of a RFFE based on the third output.

Aspect 4: The method of Aspect 3, wherein adjusting operation of the RFFE based on the third output comprises adjusting an amplifier gain; adjusting beamforming parameters, or adjusting an aperture tuner or impedance tuner configuration of one or more antennas.

Aspect 5: The method of Aspect 2, wherein: the third output comprises a classification of an object in an environment; and the sensor data comprises a representation of the environment.

Aspect 6: The method of any one of Aspects 1-5, wherein causing activation of the actuator model comprises sending a signal to a device comprising the actuator model.

Aspect 7: The method of any one of Aspects 1-6, wherein the sensor comprises an antenna, a touch screen, a button, a motion sensor, a touch sensor, a capacitive sensor, or a light sensor.

Aspect 8: The method of any one of Aspects 1-7, wherein inputting the sensor data to the selector model based on the first output comprises inputting the sensor data to the selector model in response to the first output indicating the change between the sensor data and previous sensor data satisfies a condition.

Aspect 9: The method of any one of Aspects 1-8, wherein: the gating model comprises a first neural network with a first input layer configured to receive the sensor data and a first output layer configured to output the first output; the selector model comprises a second neural network with a second input layer configured to receive the sensor data and a second output layer configured to output the second output; and the actuator model comprises a third neural network with a third input layer configured to receive the sensor data and a third output layer configured to output a third output.

Aspect 10: The method of any one of Aspects 1-9, further comprising self-tuning the gating model in response to a decrease in a minimum distance between data points associated with different classifications associated with the gating model.

Aspect 11: The method of any one of Aspects 1-10, further comprising self-tuning the selector model to add a classification associated with the selector model in response to a data point outside current classifications associated with the selector model.

Aspect 12: The method of Aspect 11, further comprising adding another actuator model to the plurality of actuator models, wherein the other actuator model is associated with the added classification.

Aspect 13: The method of any one of Aspects 1-12, further comprising self-tuning the selector model to reduce a confidence score associated with the selector model in response to a data point outside current classifications associated with the selector model.

Aspect 14: The method of Aspect 13, further comprising reducing a second confidence score associated with the actuator model in response to the data point outside the current classifications associated with the selector model.

Aspect 15: An apparatus, comprising: one or more processors, coupled to one or more memories, configured to cause the apparats to perform a method in accordance with any of Aspects 1-14.

Aspect 16: An apparatus, comprising means for performing a method in accordance with any of Aspects 1-14.

Aspect 17: A non-transitory computer-readable medium comprising computer-executable instructions that, when executed by one or more processors of a processing system, cause the processing system to perform a method in accordance with any of Aspects 1-14.

Aspect 18: A computer program product embodied on a computer-readable storage medium comprising code for performing a method in accordance with any of Aspects 1-14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a microcontroller, a microprocessor, a general purpose processor, an artificial intelligence (AI) processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), a system in package (SiP), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and or like. Also, “determining” may include receiving (e.g., receiving information), accessing (e.g., accessing data in a memory) or the like. Also, “determining” may include resolving, selecting, choosing, establishing or the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

1. An apparatus, comprising:
one or more memories; and
one or more processors, coupled to the one or more memories, and configured to cause the apparatus to:
obtain sensor data from a sensor;
input the sensor data to a gating model;
obtain as output from the gating model a first output indicating a change between the sensor data and previous sensor data;
input the sensor data to a selector model based on the first output;
obtain as output from the selector model a second output indicating an actuator model of a plurality of actuator models, wherein each of the plurality of actuator models is associated with a different classification of sensor data; and
cause activation of the actuator model based on the second output.

2. The apparatus of claim 1, wherein to cause activation of the actuator model, the one or more processors are configured to cause the apparatus to:
input at least a portion of the sensor data to the actuator model; and
obtain as output from the actuator model a third output.

3. The apparatus of claim 2, wherein the one or more processors are configured to cause the apparatus to:
adjust operation of a radio frequency front end (RFFE) based on the third output.

4. The apparatus of claim 3, wherein to adjust operation of the RFFE based on the third output, the one or more processors are configured to cause the apparatus to at least one of:
adjust an amplifier gain;
adjust beamforming parameters; or
adjust an aperture tuner or impedance tuner configuration of one or more antennas.

5. The apparatus of claim 2, wherein:
the third output comprises a classification of an object in an environment; and
the sensor data comprises a representation of the environment.

6. The apparatus of claim 1, wherein to cause activation of the actuator model, the one or more processors are configured to cause the apparatus to send a signal to a device comprising the actuator model.

7. The apparatus of claim 1, wherein the sensor comprises an antenna, a touch screen, a button, a motion sensor, a touch sensor, a capacitive sensor, or a light sensor.

8. The apparatus of claim 1, wherein to input the sensor data to the selector model based on the first output, the one or more processors are configured to cause the apparatus to:
input the sensor data to the selector model in response to the first output indicating the change between the sensor data and previous sensor data satisfies a condition.

9. The apparatus of claim 1, wherein:
the gating model comprises a first neural network with a first input layer configured to receive the sensor data and a first output layer configured to output the first output;
the selector model comprises a second neural network with a second input layer configured to receive the sensor data and a second output layer configured to output the second output; and
the actuator model comprises a third neural network with a third input layer configured to receive the sensor data and a third output layer configured to output a third output.

10. The apparatus of claim 1, the one or more processors are configured to cause the apparatus to self-tune the gating model in response to a decrease in a minimum distance between data points associated with different classifications associated with the gating model.

11. The apparatus of claim 1, the one or more processors are configured to cause the apparatus to self-tune the selector model to add a classification associated with the selector model in response to a data point outside current classifications associated with the selector model.

12. The apparatus of claim 11, the one or more processors are configured to cause the apparatus to add another actuator model to the plurality of actuator models, wherein the other actuator model is associated with the added classification.

13. The apparatus of claim 1, the one or more processors are configured to cause the apparatus to self-tune the selector model to reduce a confidence score associated with the selector model in response to a data point outside current classifications associated with the selector model.

14. The apparatus of claim 13, the one or more processors are configured to cause the apparatus to reduce a second confidence score associated with the actuator model in response to the data point outside the current classifications associated with the selector model.

15. A method comprising:
obtaining sensor data from a sensor;
inputting the sensor data to a gating model;
obtaining as output from the gating model a first output indicating a change between the sensor data and previous sensor data;
inputting the sensor data to a selector model based on the first output;
obtaining as output from the selector model a second output indicating an actuator model of a plurality of actuator models, wherein each of the plurality of actuator models is associated with a different classification of sensor data; and
causing activation of the actuator model based on the second output.

16. The method of claim 15, wherein causing activation of the actuator model comprises:
inputting the sensor data to the actuator model; and
obtaining as output from the actuator model a third output.

17. The method of claim 16, further comprising:
adjusting operation of a radio frequency front end (RFFE) based on the third output.

18. The method of claim 17, wherein adjusting operation of the RFFE based on the third output comprises:
adjusting an amplifier gain;
adjusting beamforming parameters; or
adjusting an aperture tuner or impedance tuner configuration of one or more antennas.

19. The method of claim 16, wherein:
the third output comprises a classification of an object in an environment; and
the sensor data comprises a representation of the environment.

20. One or more non-transitory computer-readable media comprising executable instructions that, when executed by one more processors of an apparatus, cause the apparatus to perform operations comprising:
obtaining sensor data from a sensor;
inputting the sensor data to a gating model;
obtaining as output from the gating model a first output indicating a change between the sensor data and previous sensor data;
inputting the sensor data to a selector model based on the first output;
obtaining as output from the selector model a second output indicating an actuator model of a plurality of actuator models, wherein each of the plurality of actuator models is associated with a different classification of sensor data; and
causing activation of the actuator model based on the second output.
